(19) United States
(12) Patent Application Publication
(10) Pub. No.: US 2019/0012613 A1
(43) Pub. Date: Jan. 10, 2019

(54) OPERATION MANAGEMENT METHOD, OPERATION MANAGEMENT APPARATUS, AND OPERATION MANAGEMENT PROGRAM

(71) Applicant: FUJITSU LIMITED, Kawasaki-shi (JP)

(72) Inventors: Takuro Ikeda, Yokohama (JP); Taizo ANAN, Kawasaki (JP)

(73) Assignee: FUJITSU LIMITED, Kawasaki-shi (JP)

(21) Appl. No.: 16/023,402

(22) Filed: Jun. 29, 2018

(30) Foreign Application Priority Data
Jul. 10, 2017 (JP) 2017-134872

(51) Int. Cl. G06Q 10/02

(52) U.S. Cl. CPC G06Q 10/02

(57) ABSTRACT

An operation management method performed by a computer, the method including: acquiring requests from a plurality of users for boarding and alighting including a departure location and a destination; associating each request with a vehicle corresponding to the departure location and the destination; setting, for each of the requests, a boarding/alighting point within a predetermined range including the departure location and within a predetermined range including the destination, respectively; generating a plurality of paths that pass through the boarding/alighting points; and selecting an operation path of the vehicle from the plurality of paths.

### CROSS-REFERENCE TO RELATED APPLICATION

This application is based upon and claims the benefit of priority of the prior Japanese Patent Application No. 2017-134872, filed on Jul. 10, 2017, the entire contents of which are incorporated herein by reference.

### FIELD

The embodiments discussed herein are related to an operation management method, an operation management apparatus, and an operation management program.

### BACKGROUND

An operation system that uses an on-demand vehicle which operates in response to a request from a user is devised in the related art. There are several kinds of on-demand vehicles, and one of those is a detouring on-demand bus.

The detouring on-demand bus is one operation form of a route bus. In response to a request from a user, the detouring on-demand bus detours along a detour route apart from a base route to a bus stop at which the user desires to board and alight. When there is no request from a user, the detouring on-demand bus operates without passing along the detour route.

Japanese Laid-open Patent Publication No. 2001-229495 is an example of the related art. Japanese Laid-open Patent Publication No. 2013-186541 is an example of the related art.

In the on-demand bus in the related art, when the distance to a boarding point from a departure location or the distance to a destination from an alighting point is long, the user walks a long distance, and convenience deteriorates. When the on-demand bus passes along the detour route in response to a request from the user, the in-vehicle travel time for each passenger is extended as the number of detours is increased. Thus, for the user, the in-vehicle travel time is excessively extended, and convenience deteriorates. From the viewpoint of a transportation operator, a problem arises in that operation efficiency is significantly decreased.

An object of the disclosed technology is to provide an operation management method, an operation management apparatus, and an operation management program that improve convenience and operation efficiency.

### SUMMARY

According to an aspect of the invention, an operation management method performed by a computer, the method including: acquiring requests from a plurality of users for boarding and alighting including a departure location and a destination; associating each request with a vehicle corresponding to the departure location and the destination; setting, for each of the requests, a boarding/alighting point within a predetermined range including the departure location and within a predetermined range including the destination, respectively; generating a plurality of paths that pass through the boarding/alighting points; and selecting an operation path of the vehicle from the plurality of paths.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one example of an operation management system of a first embodiment;

FIG. 2 is a diagram illustrating one example of a hardware configuration of an operation management apparatus of the first embodiment;

FIG. 3 is a diagram illustrating one example of a user database of the first embodiment;

FIG. 4 is a diagram illustrating one example of a vehicle database of the first embodiment;

FIGS. 5A and 5B are diagrams illustrating one example of a map database of the first embodiment;

FIG. 6 is a diagram illustrating one example of a boarding request database of the first embodiment;

FIGS. 7A and 7B are diagrams illustrating one example of an operation schedule database of the first embodiment;

FIG. 8 is a diagram illustrating one example of a reservation database of the first embodiment;

FIG. 9 is a diagram for describing a functional configuration of each apparatus included in the operation management system of the first embodiment;

FIG. 10 is a diagram for describing extraction of boarding and alighting positions in the first embodiment;

FIG. 11 is a diagram for describing decision of an operation path in the first embodiment;

FIG. 12 is a flowchart for describing the operation of a terminal apparatus of the first embodiment;

FIG. 13 is a first flowchart for describing the operation of the operation management apparatus of the first embodiment;

FIG. 14 is a second flowchart for describing the operation of the operation management apparatus of the first embodiment;

FIG. 15 is a diagram illustrating an example of display on the terminal apparatus of the first embodiment;

FIG. 16 is a diagram for describing a functional configuration of an operation management apparatus of a second embodiment;

FIG. 17 is a diagram illustrating one example of a reservation database of the second embodiment;

FIG. 18 is a flowchart for describing the operation of the operation management apparatus of the second embodiment;

FIG. 19 is a diagram for describing a functional configuration of an operation management apparatus of a third embodiment;

FIGS. 20A to 20E are diagrams for describing aggregation of boarding/alighting points in the third embodiment; and

FIG. 21 is a flowchart for describing the operation of the operation management apparatus of the third embodiment.

### DESCRIPTION OF EMBODIMENTS

### First Embodiment

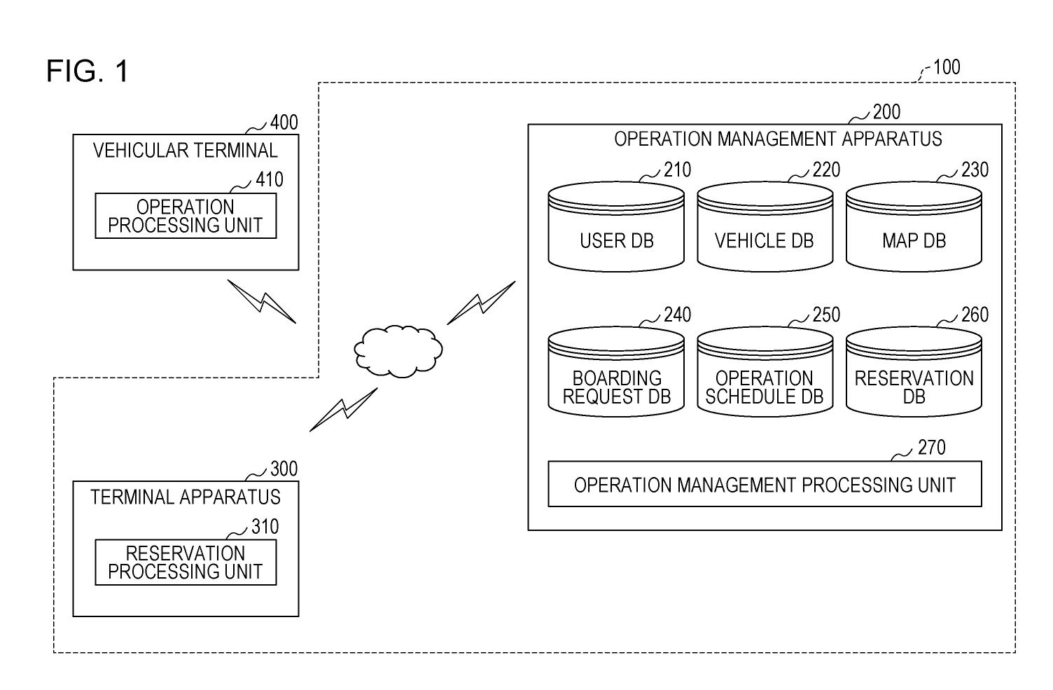

Hereinafter, the present embodiment will be described with reference to the drawings. FIG. 1 is a diagram illustrating one example of an operation management system of a first embodiment.

An operation management system 100 of the present embodiment includes an operation management apparatus 200 and a terminal apparatus 300. In the operation management system 100 of the present embodiment, the operation management apparatus 200 and the terminal apparatus 300 are connected to each other through a network. While one terminal apparatus 300 is present in the example in FIG. 1, any number of terminal apparatuses 300 may be included in the operation management system 100.

The operation management apparatus 200 of the present embodiment may communicate with a vehicular terminal 400 mounted in a vehicle of which the operation is managed by the operation management system 100. The vehicle of which the operation is managed by the operation management system 100 is, for example, an on-demand bus. The on-demand bus is a bus that operates in response to a request from a user. The vehicle of which the operation is managed by the operation management system 100 may be a vehicle such as a shared-ride taxi other than the on-demand bus.

In the operation management system 100 of the present embodiment, when a request related to boarding and alighting for the on-demand bus is input into the terminal apparatus 300, the request related to boarding and alighting is transmitted to the operation management apparatus 200 from the terminal apparatus 300. In the following description, the request related to boarding and alighting for the on-demand bus (vehicle) will be referred to as a boarding request.

When the operation management apparatus 200 receives the boarding request from the terminal apparatus 300, the operation management apparatus 200 allocates a boarding vehicle to the user of the terminal apparatus 300 based on a desired departure time period (herein after, “time period” is simply referred to as “time”) included in the boarding request. When a departure time of the allocated boarding vehicle approaches, the operation management apparatus 200 decides an operation path of the on-demand bus based on the boarding request of the user to which the boarding vehicle is allocated.

At this point, the operation management apparatus 200 of the present embodiment selects an operation path for which the satisfaction level of the user acquired from a walking time from a departure location to a boarding point, a walking time from an alighting point to a destination, an in-vehicle travel time, and the like of the user is the highest among a plurality of operation path candidates.

Therefore, the operation management system 100 of the present embodiment can improve the convenience and the operation efficiency of the on-demand bus.

The operation management apparatus 200 of the present embodiment includes a user database 210, a vehicle database 220, a map database 230, a boarding request database 240, an operation schedule database 250, a reservation database 260, and an operation management processing unit 270.

The user database 210 of the present embodiment stores information related to the user of the operation management system 100. The vehicle database 220 stores information related to the vehicle used as the on-demand bus. The map database 230 stores information related to roads.

The boarding request database 240 stores the boarding request transmitted from the terminal apparatus 300. The operation schedule database 250 stores information related to an operation schedule of the on-demand bus. The reservation database 260 stores information related to a reservation of each user for boarding the on-demand bus.

Details of each database included in the operation management apparatus 200 of the present embodiment will be described later. While the operation management apparatus 200 includes each database in the example in FIG. 1, embodiments are not limited thereto. For example, each database may be stored in a storage device that is disposed outside the operation management apparatus 200.

When an operation starting time of the on-demand bus approaches, the operation management processing unit 270 decides the operation path based on the boarding request received from the terminal apparatus 300 of the user to which the on-demand bus is allocated.

The terminal apparatus 300 of the present embodiment includes a reservation processing unit 310. The reservation processing unit 310 reserves the on-demand bus boarded by the user of the terminal apparatus 300.

The vehicular terminal 400 of the present embodiment includes an operation processing unit 410. The operation processing unit 410 receives information related to the operation path transmitted from the operation management apparatus 200, and displays the operation path on a display device or the like of the vehicular terminal 400.

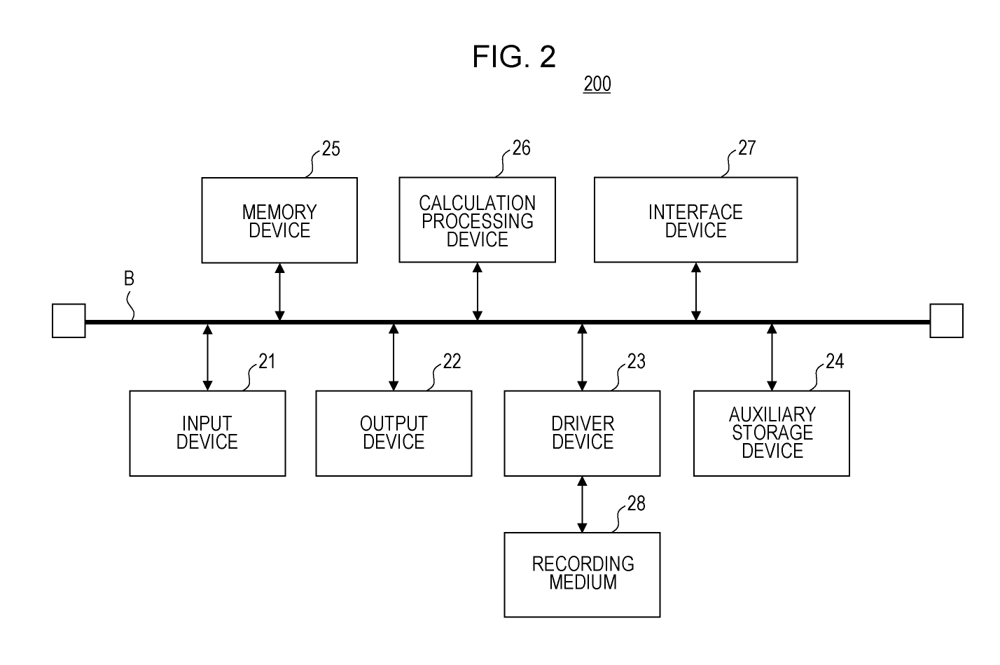

Hereinafter, a hardware configuration of each apparatus included in the operation management system 100 of the present embodiment will be described. FIG. 2 is a diagram illustrating one example of a hardware configuration of the operation management apparatus of the first embodiment.

The operation management apparatus 200 of the present embodiment includes an input device 21, an output device 22, a drive device 23, an auxiliary storage device 24, a memory device 25, a calculation processing device 26, and an interface device 27 that are connected to each other through a bus B.

The input device 21 is a device such as a mouse or a keyboard that is used for input of various signals and display of various kinds of information. The output device 22 is a device such as a display that is used for outputting various kinds of information.

The interface device 27 includes a modem, a LAN card, and the like and is used for connection to the network.

An operation management program is at least a part of various programs that control the operation management apparatus 200. For example, the operation management program is distributed using a recording medium 28 or is provided as a download from the network. Various types of recording media such as recording media on which information is optically, electrically, or magnetically recorded like a CD-ROM, a flexible disk, and a magneto-optical disc, semiconductor memories on which information is electrically recorded like a ROM and a flash memory can be used as the recording medium 28 on which the operation management program is recorded.

When the recording medium 28 on which the operation management program is recorded is set in the drive device 23, the operation management program is installed on the auxiliary storage device 24 from the recording medium 28 through the drive device 23. The operation management program that is downloaded from the network is installed on the auxiliary storage device 24 through the interface device 27.

The auxiliary storage device 24 stores the installed operation management program and also stores used files, data, and the like. The memory device 25 reads the operation management program from the auxiliary storage device 24 and stores the operation management program when the operation management apparatus 200 is started. The calculation processing device 26 implements various processes described later in accordance with the operation management program stored in the memory device 25.

The terminal apparatus 300 of the present embodiment is a general tablet computer, a smartphone, or the like. A hardware configuration of the terminal apparatus 300 is the same as the operation management apparatus 200 except for including a display operating device instead of the input device and the output device. Thus, a description of the hardware configuration of the terminal apparatus 300 will not be repeated. The terminal apparatus 300 may be a terminal apparatus other than a tablet computer or a smartphone. Specifically, for example, the terminal apparatus 300 may be a laptop computer or may be a general desktop computer.

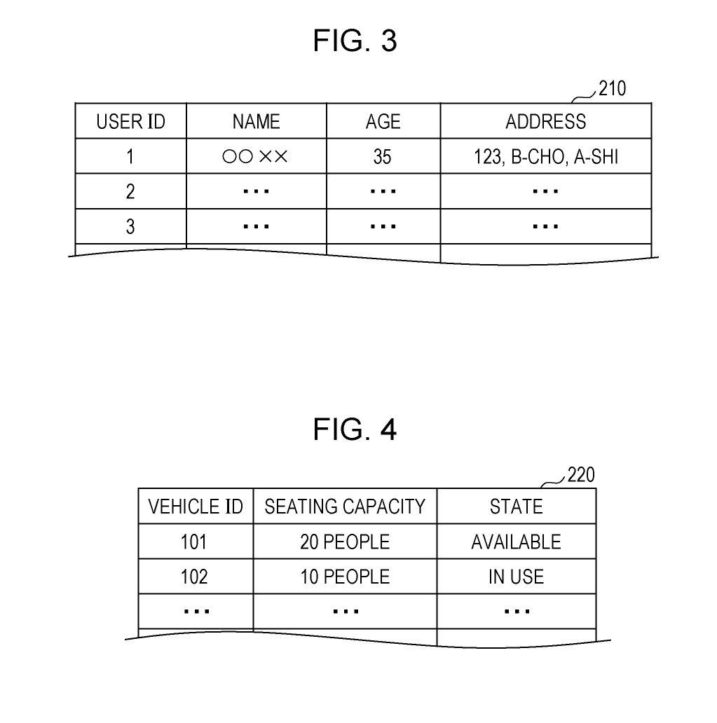

Next, each database included in the operation management apparatus 200 of the present embodiment will be described. FIG. 3 is a diagram illustrating one example of the user database of the first embodiment.

The user database 210 of the present embodiment stores information related to the user of the operation management system 100. The user database 210 includes a user ID, a name, an age, an address, and the like as fields of information. The field “user ID” is associated with the other fields.

The value of the field “user ID” is an identifier for identifying the user and may be, for example, an identifier of the terminal apparatus 300 carried by the user. The values of the fields “name”, “age”, and “address” indicate the name, the age, and the address of the user, respectively. In the following description, information that includes the value of the field “user ID” and the values of the other fields will be referred to as user information.

The user database 210 of the present embodiment may include fields other than the above fields. The user database 210 desirably includes at least the user ID as a field of information.

Next, the vehicle database 220 will be described with reference to FIG. 4. FIG. 4 is a diagram illustrating one example of the vehicle database of the first embodiment.

The vehicle database 220 of the present embodiment stores information related to the vehicle used as the on-demand bus. The vehicle database 220 of the present embodiment includes a vehicle ID, a seating capacity, and a state as fields of information. The field “vehicle ID” is associated with the other fields.

The value of the field “vehicle ID” is an identifier that specifies a vehicle. The value of the field “seating capacity” is a seating capacity that is the number of people who can board the vehicle indicated by the corresponding vehicle ID. The value of the field “state” indicates whether or not the vehicle indicated by the corresponding vehicle ID is in operation. For example, when the value of the field “state” is “in use”, the vehicle indicated by the corresponding vehicle ID is in operation as the on-demand bus. When the value of the field “state” is “available”, the vehicle indicated by the corresponding vehicle ID is not in operation.

The vehicle database 220 may include other fields. For example, the vehicle database 220 may include the current positional information for each vehicle ID.

The vehicle database 220 may not include all fields of information illustrated in FIG. 4.

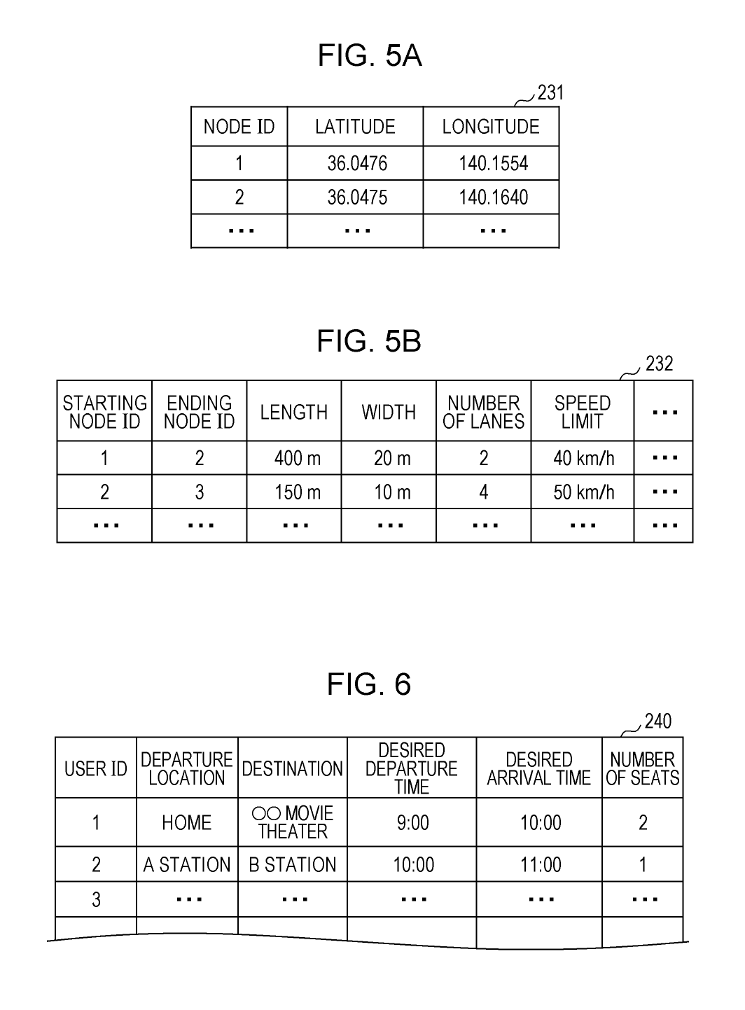

Next, the map database 230 of the present embodiment will be described with reference to FIGS. 5A and 5B. FIGS. 5A and 5B are diagrams illustrating one example of the map database of the first embodiment. The map database 230 of the present embodiment represents map data as a network that is configured with nodes and links connecting the nodes. In other words, the map database 230 of the present embodiment includes node information that stores positional information of nodes, and link information that stores information related to links connecting the nodes.

FIG. 5A is a diagram illustrating one example of the node information, and FIG. 5B is a diagram illustrating one example of the link information.

The node information of the present embodiment includes a node ID, a latitude, and a longitude as fields. The field “node ID” is associated with the other fields.

The value of the field “node ID” is an identifier for identifying each node. The values of the fields “latitude” and “longitude” indicate the latitude and the longitude of the node indicated by the corresponding node ID.

The link information of the present embodiment includes a starting node ID, an ending node ID, a length, a width, the number of lanes, a speed limit, and the like as fields. In other words, the link information of the present embodiment is attribute information that indicates attributes of roads.

The value of the field “starting node ID” is the node ID that indicates a node of the starting point of a link. The value of the field “ending node ID” is the node ID that indicates a node of the ending point of a link. The value of the field “length” indicates the length of a link. The value of the field “width” indicates the width of a link. The value of the field “number of lanes” indicates the number of lanes of a link (road). The value of the field “speed limit” indicates a speed limit in a link.

The link information of the present embodiment may include, for example, the presence of a signal and traffic regulation information other than the above fields.

Next, the boarding request database 240 of the present embodiment will be described with reference to FIG. 6. FIG. 6 is a diagram illustrating one example of the boarding request database of the first embodiment.

The boarding request database 240 of the present embodiment stores the boarding request received from the terminal apparatus 300.

The boarding request database 240 includes a user ID, a departure location, a destination, a desired departure time, a desired arrival time, and the number of seats as fields of information. The field “user ID” is associated with the other fields. The boarding request of the present embodiment is information that includes the value of the field “user ID” and the values of the other fields.

The value of the field “departure location” indicates the departure location of the user. For example, the value of the field “departure location” of the present embodiment may be a position indicated by positional information that is acquired by a global positioning system (GPS) function of the terminal apparatus 300 carried by the user.

The value of the field “destination” indicates the destination of the user. The value of the field “desired departure time” indicates a departure time desired by the user. The value of the field “desired arrival time” indicates an arrival time desired by the user. The value of the field “number of seats” indicates the number of seats used by the user.

For example, in FIG. 6, in the boarding request of a user ID “1”, the departure location is the home of the user, and the destination is 00 movie theater. The desired departure time is 9:00, and the desired arrival time as 10:00. Seats for two people are used.

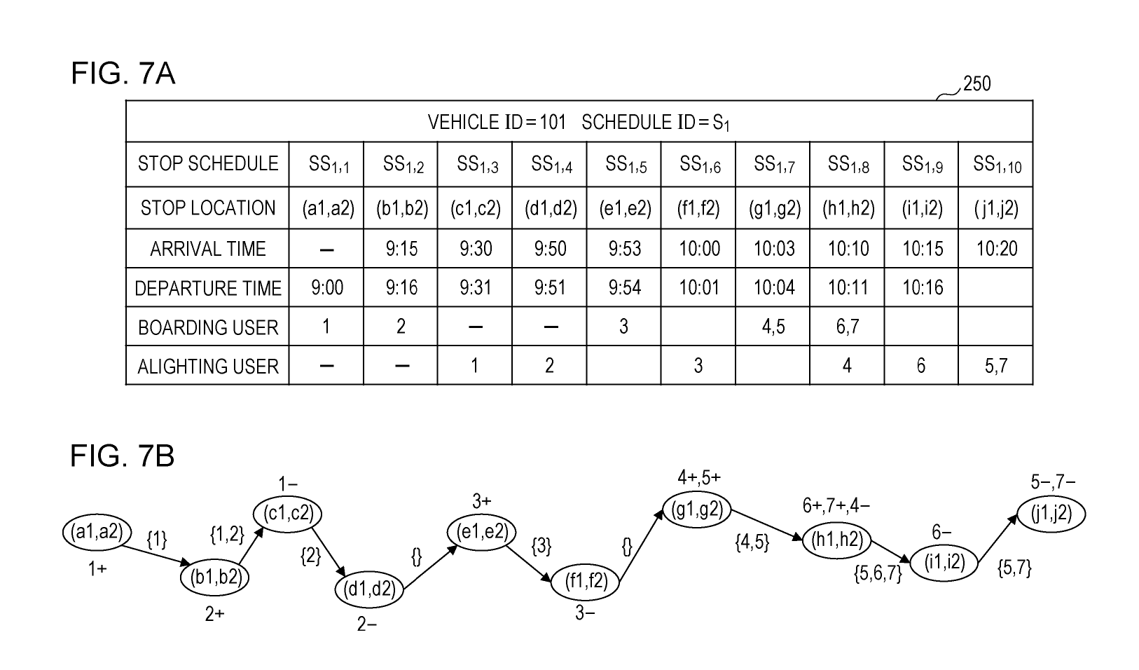

Next, the operation schedule database 250 of the present embodiment will be described with reference to FIGS. 7A and 7B. FIGS. 7A and 7B are diagrams illustrating one example of the operation schedule database of the first embodiment. FIG. 7A is a diagram illustrating one example of the operation schedule database 250, and FIG. 7B is a diagram illustrating a behavior of the vehicle in accordance with the operation schedule illustrated in FIG. 7A.

The operation schedule database 250 of the present embodiment stores information related to the operation schedule of the on-demand bus that is based on the operation path decided by the operation management processing unit 270.

The operation schedule database 250 of the present embodiment is provided for each operation schedule. In other words, the operation schedule database 250 is provided for each schedule ID for specifying an operation schedule. In the operation schedule database 250, the schedule ID is associated with the vehicle ID that specifies the vehicle of the on-demand bus operating on the operation schedule indicated by the schedule ID.

The example in FIG. 7A illustrates an operation schedule that corresponds to a vehicle ID “101” and a schedule ID “Sᵢ”. That is, the operation schedule database 250 indicates that a vehicle (on-demand bus) indicated by the vehicle ID “101” operates in accordance with the schedule ID “Sᵢ”.

The operation schedule database 250 of the present embodiment includes a stop schedule, a stop location, an arrival time, a departure time, a boarding user, and an alighting user as fields of information.

The value of the field “stop schedule” indicates a stop schedule at a stop location described later. The value of the field “stop location” indicates the latitude and the longitude of a location where the on-demand bus stops. That is, in the operation schedule database 250, the operation path of the on-demand bus is confirmed by the stop schedule and the stop location. The position indicated by the value of the field “stop location” is a boarding point/alighting point of the user for the on-demand bus.

The value of the field “arrival time” indicates a time when the on-demand bus arrives at the corresponding stop location. The value of the field “departure time” indicates a time when the on-demand bus departs from the corresponding stop location. The value of the field “boarding user” indicates the user ID of the user who boards the on-demand bus at the corresponding stop location. The value of the field “alighting user” indicates the user ID of the user who alights from the on-demand bus at the corresponding stop location.

In the following description, information that includes the schedule ID and the value of each field associated with the schedule ID in the operation schedule database 250 will be referred to as operation schedule information.

In the operation schedule information illustrated in FIG. 7A, there are 10 stop schedules of SS_{1,1} to SS_{1,10}. In the operation schedule information illustrated in FIG. 7A, at the stop schedule SS_{1,1}, a user of the user ID “1” boards the on-demand bus at a point having a latitude and a longitude of (a1, a2), and the on-demand bus departs from the point at 9:00.

In the operation schedule information illustrated in FIG. 7A, at the stop schedule SS_{1,2}, the on-demand bus arrives and stops at a point having a latitude and a longitude of (b1, b2) at 9:15. A user of a user ID “2” boards the on-demand bus, and the on-demand bus departs from the point at 9:16.

Based on the operation schedule information illustrated in FIG. 7A, the behavior of the vehicle (on-demand bus) can be illustrated as in FIG. 7B.

In FIG. 7B, the user of the user ID “1” boards at a node having a latitude and a longitude of (a1, a2). The number of passengers in the on-demand bus is one until the subsequent stop location that is a node having a latitude and a longitude of (b1, b2). The user of the user ID “2” boards at the node having a latitude and a longitude of (b1, b2). The number of passengers in the on-demand bus is two who are the user of the user ID “1” and the user of the user ID “2” until the subsequent stop location that is a node having a latitude and a longitude of (c1, c2).

The user of the user ID “1” alights at the node having a latitude and a longitude of (c1, c2). Thus, the number of passengers in the on-demand bus is one who is the user of the user ID “2” until the subsequent stop location that is a node having a latitude and a longitude of (d1, d2). The user of the user ID “2” alights at the node having a latitude and a longitude of (d1, d2). Thus, the number of passengers in the on-demand bus is zero until the subsequent stop location that is a node having a latitude and a longitude of (e1, e2).

That is, in FIG. 7B, a node indicates a stop location, and a number attached to the node indicates the user ID of the user who boards or alights at the stop location. A plus sign indicates boarding, and a minus sign indicates alighting. A number that is enclosed in parentheses attached to a link indicates the user ID of the user who is present in the vehicle when the vehicle moves between two stop locations.

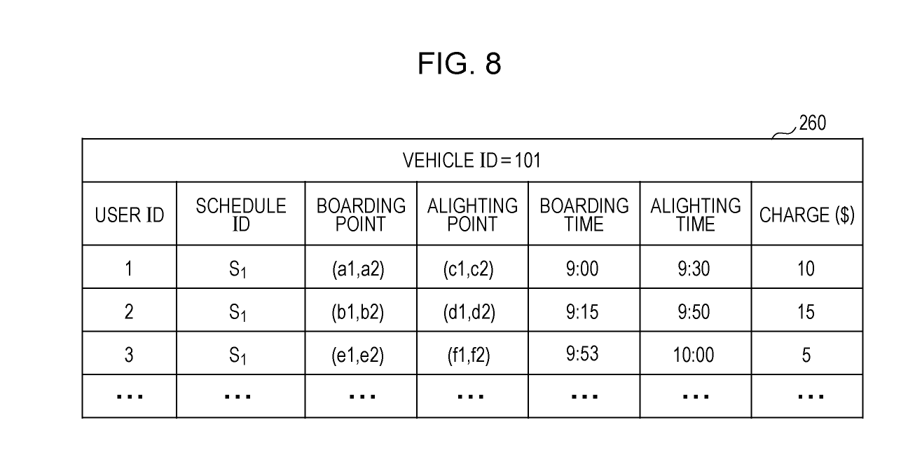

Next, the reservation database 260 of the present embodiment will be described with reference to FIG. 8. FIG. 8 is a diagram illustrating one example of the reservation database of the first embodiment.

The reservation database 260 of the present embodiment is provided for each vehicle of the on-demand bus, and stores information related to a reservation of each user for the on-demand bus based on the boarding request of the user. The reservation database 260 illustrated in FIG. 8 illustrates information related to a reservation of the user who has a reservation for the on-demand bus of the vehicle ID “101”.

The reservation database 260 includes a user ID, a schedule ID, a boarding point, an alighting point, a boarding time, an alighting time, and a charge as fields of information. In the reservation database 260, the field “user ID” is associated with the other fields. Information that includes the value of the field “user ID” and the values of the other fields will be referred to as reservation information.

The value of the field “schedule ID” is an identifier that specifies an operation schedule. In other words, the value of the field “schedule ID” is an identifier that specifies a vehicle of the on-demand bus.

The value of the field “boarding point” indicates a location where the user indicated by the corresponding user ID boards the on-demand bus. The value of the field “alighting point” indicates a location where the user indicated by the corresponding user ID alights from the on-demand bus.

The value of the field “boarding time” indicates a time when the user indicated by the corresponding user ID boards the on-demand bus. The value of the field “alighting time” indicates a time when the user indicated by the corresponding user ID alights from the on-demand bus. The value of the field “charge” indicates a charge (fare) that is applied when the user indicated by the corresponding user ID boards the on-demand bus.

In the example in FIG. 8, the user of the user ID “1” boards the on-demand bus operating on the operation schedule of the schedule ID “S₁” at the point having a latitude and a longitude of (a1, a2) at 9:00, and alights at a point having a latitude and a longitude of (c1, c2) at 9:30. At this point, the fare is 10 dollars.

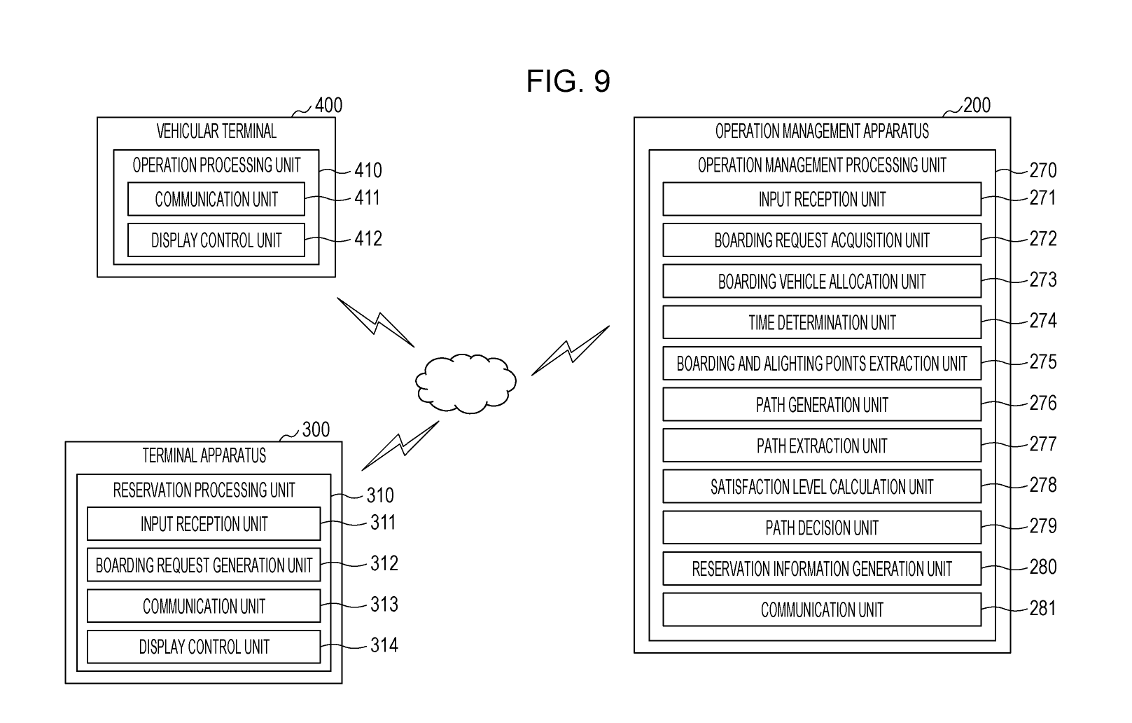

Next, a functional configuration of each apparatus included in the operation management system 100 of the present embodiment will be described with reference to FIG. 9. FIG. 9 is a diagram for describing a functional configuration of each apparatus included in the operation management system of the first embodiment.

First, functions of the operation management apparatus 200 of the present embodiment will be described. The operation management apparatus 200 of the present embodiment includes the operation management processing unit 270. The operation management processing unit 270 is implemented by the calculation processing device 26 of the operation management apparatus 200 reading and executing the operation management program stored in the memory device 25 or the like.

The operation management processing unit 270 of the present embodiment includes an input reception unit 271, a boarding request acquisition unit 272, a boarding vehicle allocation unit 273, a time determination unit 274, a boarding/alighting points extraction unit 275, a path generation unit 276, a path extraction unit 277, a satisfaction level calculation unit 278, a path decision unit 279, a reservation information generation unit 280, and a communication unit 281.

The input reception unit 271 of the present embodiment receives input of various kinds of information provided to the operation management apparatus 200. The boarding request acquisition unit 272 acquires the boarding request received from the terminal apparatus 300.

The boarding vehicle allocation unit 273 allocates, based on the boarding request, the on-demand bus (boarding vehicle) to the user who makes the boarding request. In other words, the boarding vehicle allocation unit 273 associates the user ID and a range of time close to the desired departure time with the vehicle ID of the on-demand bus that is scheduled to pass near the point of the departure location.

In the present embodiment, for example, the on-demand bus is configured to operate at predetermined intervals. Thus, the boarding vehicle allocation unit 273 may associate the user ID included in the boarding request with the vehicle ID of the on-demand bus corresponding to the boarding request. For example, the schedule of the on-demand bus that operates at predetermined intervals may be stored in the vehicle database 220.

The time determination unit 274 determines whether or not the current time is close to the departure time of the on-demand bus. Specifically, for example, the time determination unit 274 determines whether or not a time period from the current time to the departure time of the on-demand bus is shorter than or equal to a predetermined time period. For example, the predetermined time period may be approximately one hour or approximately 10 minutes.

The boarding/alighting points extraction unit 275 extracts boarding/alighting points as the stop location based on the boarding request when the time determination unit 274 determines that the current time is close to the operation starting time. The boarding/alighting points may include the departure location and the destination included in the boarding request. Details of the process of the boarding/alighting points extraction unit 275 will be described later. The term “boarding/alighting point” means a location point at which the vehicle stops, and do not necessarily mean a point at which both a boarding passenger and an alighting passenger exist. Namely, there may be only a passenger to board or only a passenger to alight, at the boarding/alighting point.

The path generation unit 276 generates paths that include all boarding/alighting points extracted by the boarding/alighting points extraction unit 275.

The path extraction unit 277 extracts, from the paths generated by the path generation unit 276, a path as a satisfaction level calculation target by the satisfaction level calculation unit 278. Specifically, the path extraction unit 277 extracts a path for which the whole in-vehicle travel time satisfies a preset constraint among the paths generated by the path generation unit 276. The whole in-vehicle travel time is a time period that is taken when the on-demand bus travels to the ending point from the starting point of the path. In other words, the whole in-vehicle travel time is a time period from the departure time of the on-demand bus at the starting point to the arrival time of the on-demand bus at the ending point.

For example, the path extraction unit 277 of the present embodiment may calculate the in-vehicle travel time for each user. When a user of which the in-vehicle travel time is longer than a predetermined threshold is present among the users, the path extraction unit 277 may exclude the path. For example, the predetermined threshold may be a time period that is twice as long as the in-vehicle travel time when the user moves the shortest distance to the destination from the departure location of the user by taxi.

The satisfaction level calculation unit 278 calculates the satisfaction level of the user for each path generated by the path generation unit 276.

The path decision unit 279 decides the operation path along which the on-demand bus travels, from the paths generated by the path generation unit 276 based on the satisfaction level calculated by the satisfaction level calculation unit 278. The path decision unit 279 stores the operation schedule information based on the decided operation path in the operation schedule database 250. Specifically, the path decision unit 279 decides the operation path to be a path for which the total of the satisfaction levels calculated by the satisfaction level calculation unit 278 is the highest.

Details of the processes of the path generation unit 276, the satisfaction level calculation unit 278, and the path decision unit 279 will be described later.

The reservation information generation unit 280 generates, based on the operation path decided by the path decision unit 279, the reservation information of the user for each user ID associated with the vehicle ID of the on-demand bus that travels along the operation path. The reservation information generation unit 280 stores the reservation information in the reservation database 260.

The communication unit 281 is a unit that communicates with external apparatuses including the terminal apparatus 300 and the vehicular terminal 400.

Next, functions of the terminal apparatus 300 will be described. The terminal apparatus 300 of the present embodiment includes the reservation processing unit 310.

The reservation processing unit 310 includes an input reception unit 311, a boarding request generation unit 312, a communication unit 313, and a display control unit 314.

The input reception unit 311 of the present embodiment receives input provided to the terminal apparatus 300. Specifically, the input reception unit 311 receives input of information provided by the user.

The boarding request generation unit 312 generates the boarding request based on the content received by the input reception unit 311. The communication unit 313 transmits and receives information with the operation management apparatus 200. The display control unit 314 controls display in the terminal apparatus 300.

Next, the vehicular terminal 400 will be described. The vehicular terminal 400 includes the operation processing unit 410.

The operation processing unit 410 of the present embodiment includes a communication unit 411 and a display control unit 412. The communication unit 411 communicates with external apparatuses including the operation management apparatus 200. The display control unit 412 control display in a display unit included in the vehicular terminal 400.

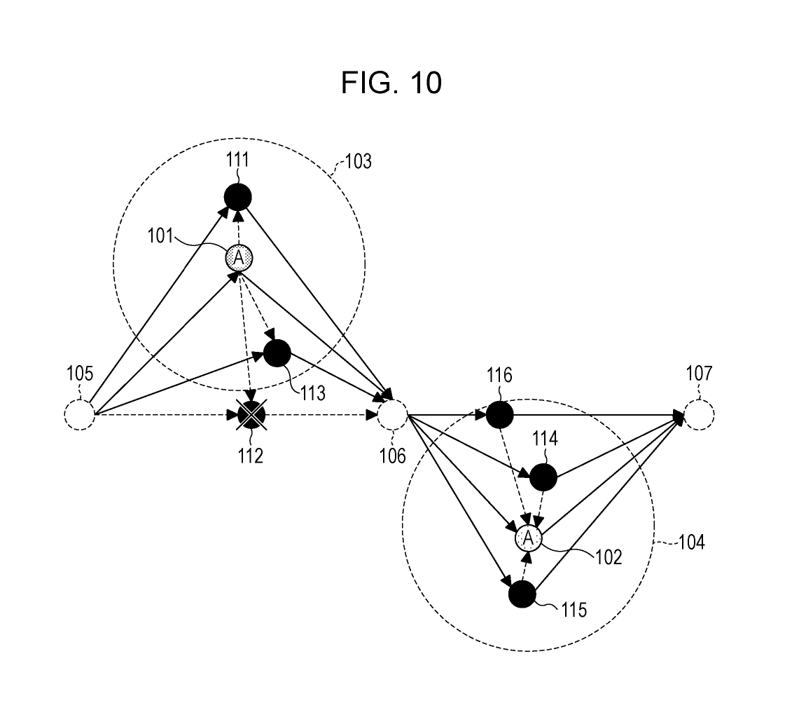

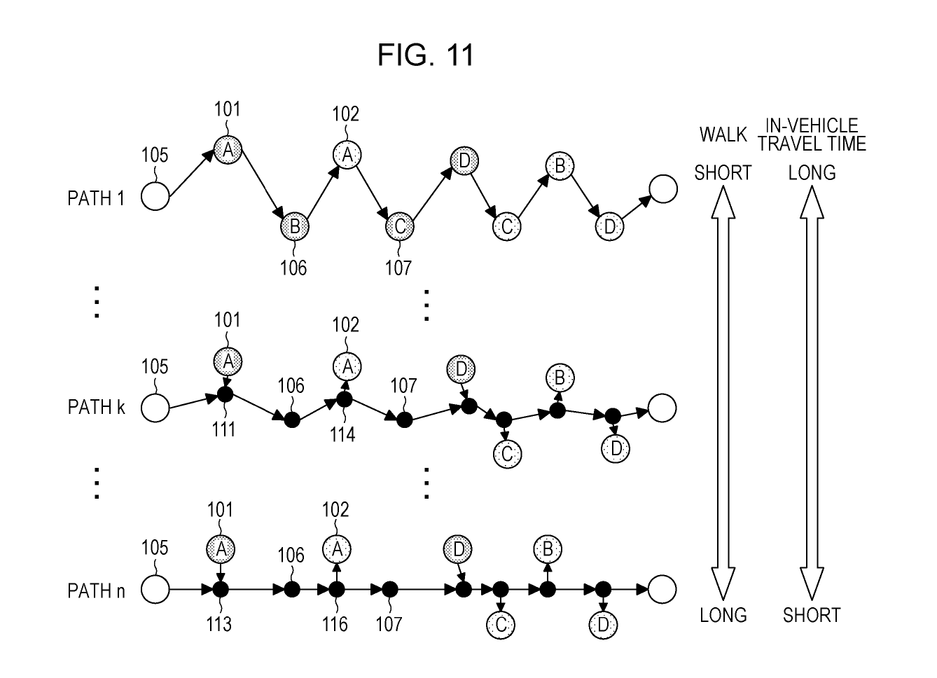

Next, each of the processes of the boarding/alighting points extraction unit 275, the path generation unit 276, the satisfaction level calculation unit 278, and the path decision unit 279 of the operation management processing unit 270 of the present embodiment will be described with reference to FIG. 10 and FIG. 11.

FIG. 10 is a diagram for describing extraction of boarding and alighting positions in the first embodiment. The boarding/alighting points extraction unit 275 of the present embodiment extracts boarding/alighting points for each group of users having close departure locations or destinations among the users allocated to the same on-demand bus (boarding vehicle).

For example, the boarding/alighting points extraction unit 275 of the present embodiment extracts points within a walkable range centered at the departure location or the destination included in the boarding request as the boarding/alighting points. At this point, the boarding/alighting points extraction unit 275 preferably extracts a plurality of boarding/alighting points. In the present embodiment, for example, the walkable range may be approximately 100 meters.

Specifically, the boarding/alighting points extraction unit 275 acquires the positional information indicating the positions of the departure location and the destination included in the boarding request, and extracts a plurality of boarding/alighting points within a predetermined range from the points indicated by the positional information. For example, the positional information may be acquired by referring to the map database 230.

For example, FIG. 10 illustrates a case where a point 101 is the departure location included in the boarding request of a user A, and a point 102 is the destination included in the boarding request of the user A.

In this case, the boarding/alighting points extraction unit 275 extracts a plurality of boarding/alighting points from a predetermined range 103 that is centered at the point 101. Similarly, the boarding/alighting points extraction unit 275 extracts a plurality of boarding/alighting points from a predetermined range 104 that is centered at the point 102.

At this point, the boarding/alighting points extraction unit 275 may refer to the map database 230 and extract a road having a road width through which the operating vehicle of the on-demand bus can pass, or a road having a plurality of lanes as boarding/alighting points. That is, the boarding/alighting points extraction unit 275 of the present embodiment extracts boarding/alighting points by referring to the link information (attribute information) in the map database 230.

In the present embodiment, extracting boarding/alighting points in the above manner can suppress a blockage of the flow of traffic accompanied by a stop of the on-demand bus.

For example, the boarding/alighting points extraction unit 275 may extract the departure location and the destination included in the boarding request as boarding/alighting points, or may extract noticeable locations such as an existing bus stop, a taxi stand, and a convenience store as boarding/alighting points.

In FIG. 10, a point 105 illustrates a position where the on-demand bus stops before the user A boards, and a point 106 illustrates a position where the on-demand bus stops first after the user A boards the on-demand bus. A point 107 illustrates a position where the on-demand bus stops after the point 106.

In the example in FIG. 10, points 101, 111, and 113 are extracted as boarding/alighting points in the predetermined range 103. At this point, a point 112 is not included in the predetermined range 103 and thus, is not extracted. Points 102, 114, 115, and 116 in the predetermined range 104 are extracted as boarding/alighting points.

The boarding/alighting points extraction unit 275 of the present embodiment performs the process described with FIG. 10 for the departure locations and the destinations included in the boarding requests of all users boarding the same on-demand bus.

That is, the boarding/alighting points extraction unit 275 extracts a plurality of boarding/alighting points from predetermined ranges that are centered at the departure location and the destination of each of all users allocated to the same on-demand bus.

The operation management processing unit 270 of the present embodiment generates, using the path generation unit 276, a plurality of paths connecting the boarding/alighting points extracted by the boarding/alighting points extraction unit 275, and decides, using the path decision unit 279, the operation path for which the satisfaction level is the highest among the plurality of paths.

FIG. 11 is a diagram for describing decision of the operation path in the first embodiment. The path generation unit 276 of the present embodiment generates a plurality of paths using the extracted boarding points.

A path 1 in FIG. 11 illustrates a path that connects boarding/alighting points as the departure locations and the destinations of all passengers in the on-demand bus.

For example, the path 1 is a path in which the point 101 as the departure location of the user A and the point 102 as the destination of the user A in the predetermined ranges 103 and 104 are boarding/alighting points. In this case, a walking time of the user A is the shortest, but the distance by which the on-demand bus operates is increased. Thus, the in-vehicle travel time of passengers is extended.

A path k illustrates a path that connects boarding/alighting points other than the departure locations and the destinations of the users of the on-demand bus. Specifically, for example, in the path k, the boarding/alighting points of the user A are the point 111 in the predetermined range 103 and the point 114 in the predetermined range 104.

In this case, the user A walks to the point 111 from the point 101, and to the point 102 from the point 114. Therefore, while the distance by which the user A walks is increased, the in-vehicle travel time of the user A is reduced. The same applies to other users.

A path n illustrates a path that connects boarding points resulting in the shortest in-vehicle travel time, among the boarding/alighting points other than the departure locations and the destinations of the users of the on-demand bus. Specifically, for example, in the case of the user A, the point 113 in the predetermined range 103 and the point 116 in the predetermined range 104 are boarding/alighting points of the user A in the path n.

In this case, the user A walks to the point 113 from the point 101, and to the point 102 from the point 116. Therefore, while the distance by which the user A walks is longer than that in the path k, the in-vehicle travel time of the user A is reduced. The same applies to other users.

In the above manner, the path generation unit 276 of the present embodiment generates paths that correspond to all possible combinations acquired from the boarding/alighting points extracted by the boarding/alighting points extraction unit 275. The plurality of paths generated by the path generation unit 276 are operation path candidates of the on-demand bus.

When the operation path candidates are generated, the path extraction unit 277 extracts a path for which the whole in-vehicle travel time is shorter than a predetermined time period, and excludes the other paths. In FIG. 11, for example, the path extraction unit 277 may exclude the path 1.

At this point, the path extraction unit 277 may calculate the in-vehicle travel time for each path from the map database 230 and the average speed of the on-demand bus.

The manner of extracting paths using the path extraction unit 277 is not limited to the above method. For example, the path extraction unit 277 may exclude the path when a user of which the in-vehicle travel time is longer, by a predetermined threshold or longer, than the in-vehicle travel time at the time of moving to the destination from the departure location by taxi is present among the users of the on-demand bus.

In the present embodiment, for example, excluding such a path can suppress a phenomenon in which the in-vehicle travel time of a specific user is extended. The specific user is, for example, a user who has a long distance to move to the on-demand bus.

For example, the path extraction unit 277 of the present embodiment may calculate a variance of the satisfaction level calculated for each path, and exclude a path for which the variance is higher than or equal to a threshold. In the present embodiment, excluding such a path can exclude a path that is not fair for the users, and can suppress bias in the satisfaction level of the users boarding the on-demand bus.

In the present embodiment, when the path extraction unit 277 excludes a path that is not a satisfaction level calculation target, and extracts a path as a satisfaction level calculation target, the satisfaction level calculation unit 278 calculates the satisfaction level for each path.

Hereinafter, calculation of the satisfaction level by the satisfaction level calculation unit 278 will be described. The satisfaction level of the present embodiment is represented in Expression (1) given that the satisfaction level of a user i for the path k is U_{k,i}.

$${U}_{k , i} = {β}_{1} \frac{{TT}_{k , i} }{{D}_{i}} + {β}_{2} ( {AT}_{k , i} + {ET}_{k , i} ) + {β}_{3} \frac{{f}_{i} }{{D}_{i}} \qquad ( 1 )$$

An in-vehicle travel time is denoted by TT_{k,i}. A walking time from the departure location to a boarding point is denoted by AT_{k,i}. A walking time from a alighting point to the destination is denoted by ET_{k,i}. A charge is denoted by Fᵢ. In Expression (1), an in-vehicle travel time at the time of moving to the destination from the departure location by taxi is denoted by Dᵢ, and β₁, β₂, and β₃ are parameters.

In the above manner, the satisfaction level calculation unit 278 of the present embodiment calculates the satisfaction level of each user boarding the on-demand bus for each operation path candidate based on the in-vehicle travel time, the walking time, and the in-vehicle travel time at the time of moving by taxi. The in-vehicle travel time at the time of moving by taxi indicates a travel time when the user moves the shortest distance to the destination from the departure location.

Next, as illustrated in Expression (2), the path decision unit 279 decides the operation path of the on-demand bus to be the path k for which the total of the satisfaction levels U_{k,i} of all users i boarding the on-demand bus is the highest.

$${argmax}_{k} {\sum }_{i} {U}_{k , i} \qquad ( 2 )$$

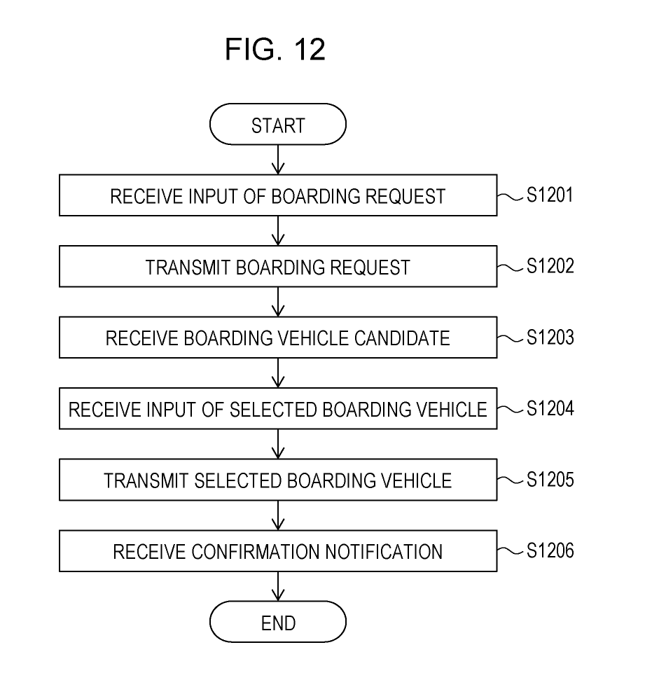

Next, the operation of each apparatus of the operation management system 100 of the present embodiment will be described with reference to FIG. 12 to FIG. 14.

First, the operation of the terminal apparatus 300 will be described with reference to FIG. 12. FIG. 12 is a flowchart for describing the operation of the terminal apparatus of the first embodiment.

In the terminal apparatus 300 of the present embodiment, the input reception unit 311 of the reservation processing unit 310 receives input of the values of the fields included in the boarding request provided to the terminal apparatus 300 (step S1201). Next, the reservation processing unit 310 generates the boarding request based on the input information using the boarding request generation unit 312, and transmits the generated boarding request to the operation management apparatus 200 using the communication unit 313 (step S1202).

Next, the reservation processing unit 310 receives information indicating boarding vehicle candidates from the operation management apparatus 200 using the communication unit 313 (step S1203). For example, the reservation processing unit 310 receives information that indicates boarding vehicles traveling near the departure location in a range of time close to the desired departure time included in the boarding request.

Specifically, for example, when the desired departure time included in the boarding request is 9:00, information that specifies an on-demand bus departing at 8:50, an on-demand bus departing at 9:00, and an on-demand bus departing at 9:10 near the departure location included in the boarding request may be received as the information indicating the boarding vehicle candidates.

Next, the reservation processing unit 310 displays the information indicating the boarding vehicle candidates on a display device using the display control unit 314, and receives selection of a boarding vehicle using the input reception unit 311 (step S1204).

Next, the reservation processing unit 310 transmits information indicating the selected boarding vehicle to the operation management apparatus 200 using the communication unit 313 (step S1205). When the communication unit 313 receives, from the operation management apparatus 200, a notification indicating that the selected boarding vehicle is accepted (step S1206), the reservation processing unit 310 finishes the process.

In the present embodiment, when the process in FIG. 12 is executed in the terminal apparatus 300, a reservation of the user of the terminal apparatus 300 for the on-demand bus is complete.

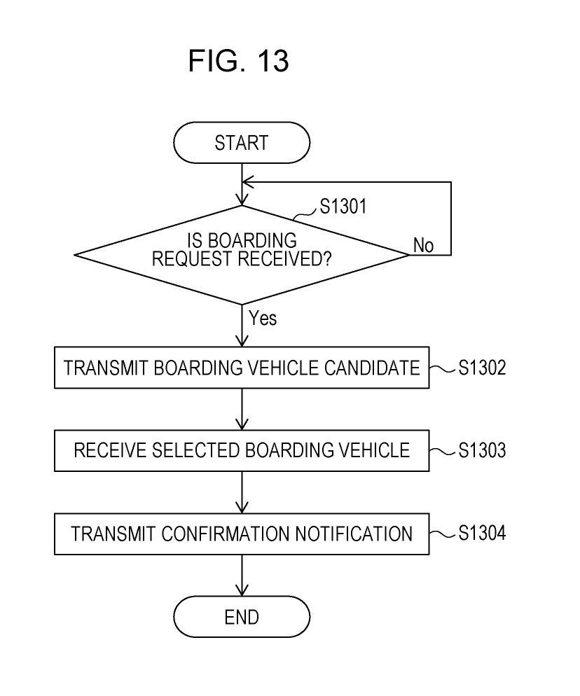

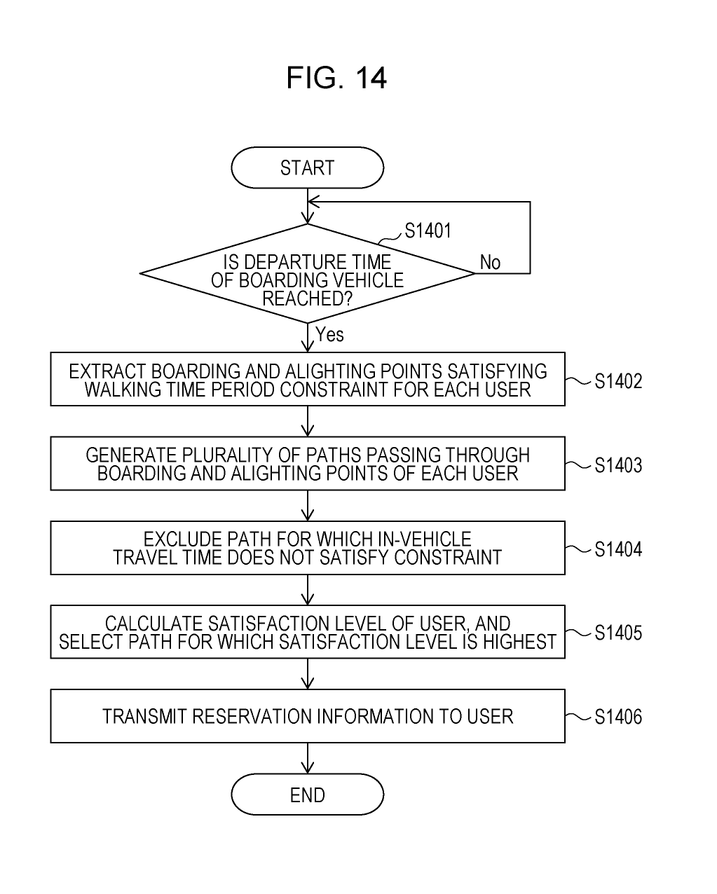

Next, the operation of the operation management apparatus 200 of the present embodiment will be described with reference to FIG. 13 and FIG. 14. FIG. 13 is a first flowchart for describing the operation of the operation management apparatus of the first embodiment.

The operation management processing unit 270 of the operation management apparatus 200 of the present embodiment determines whether or not the communication unit 281 receives the boarding request using the input reception unit 271 (step S1301). When the boarding request is not received in step S1301, the operation management processing unit 270 waits until the boarding request is received.

When the boarding request is received in step S1301, the operation management processing unit 270 acquires the received boarding request using the boarding request acquisition unit 272, allocates boarding vehicle candidates using the boarding vehicle allocation unit 273, and transmits information indicating the boarding vehicle candidates to the terminal apparatus 300 (step S1302).

Specifically, when the boarding request is received, the operation management processing unit 270 allocates boarding vehicle candidates using the boarding vehicle allocation unit 273 based on the desired departure time and the departure location included in the boarding request. The operation management processing unit 270 transmits information indicating the allocated boarding vehicle candidates to the terminal apparatus 300 using the communication unit 281.

Next, the operation management processing unit 270 receives information specifying a boarding vehicle from the terminal apparatus 300 through the communication unit 281 using the input reception unit 271 (step S1303).

Next, the operation management processing unit 270 transmits a confirmation notification indicating that the specified boarding vehicle is accepted to the terminal apparatus 300 using the communication unit 281 (step S1304), and finishes the process.

At this point, the boarding vehicle allocation unit 273 may retain the vehicle ID of the specified boarding vehicle in association with the user ID included in the boarding request.

In the present embodiment, the boarding vehicle boarded by the user of the terminal apparatus 300 is confirmed by the processes in FIG. 12 and FIG. 13.

Next, a process of deciding the operation path in the operation management processing unit 270 of the present embodiment will be described with reference to FIG. 14. FIG. 14 is a second flowchart for describing the operation of the operation management apparatus of the first embodiment.

The operation management processing unit 270 of the present embodiment determines whether or not the departure time of the vehicle ID associated with the user ID in the boarding vehicle allocation unit 273 is reached using the time determination unit 274 (step S1401). When the departure time is not reached in step S1401, the operation management processing unit 270 waits until the departure time is reached.

When the departure time is reached in step S1401, the operation management processing unit 270 extracts boarding/alighting points for each user using the boarding/alighting points extraction unit 275 based on the departure location and the destination of the user boarding the vehicle indicated by the vehicle ID of which the departure time is reached (step S1402). Next, the operation management processing unit 270 generates a plurality of path candidates using the extracted boarding/alighting points using the path generation unit 276 (step S1403).

Next, the operation management processing unit 270 excludes a path for which the in-vehicle travel time does not satisfy a predetermined constraint from a satisfaction level calculation target using the path extraction unit 277 (step S1404).

Next, the operation management processing unit 270 calculates and adds up the satisfaction level for the path as a satisfaction level calculation target for each user ID associated with the vehicle ID using the satisfaction level calculation unit 278, and selects a path for which the total of the satisfaction levels is the highest as the operation path using the path decision unit 279 (step S1405). Based on the selected operation path, the path decision unit 279 generates the operation schedule information, assigns the schedule ID to the operation schedule information, and stores the operation schedule information in the operation schedule database 250.

Next, the operation management processing unit 270 generates the reservation information for each user ID from the selected operation path using the reservation information generation unit 280 and transmits the reservation information to the terminal apparatus 300 corresponding to the user ID (step S1406), and finishes the process.

More specifically, the reservation information generation unit 280 generates the reservation information including the boarding point, the alighting point, the boarding time, the alighting time, and the charge for each user ID from the operation schedule information generated in step S1405, and stores the reservation information in the reservation database 260.

In the present embodiment, only the boarding point, the alighting point, the boarding time, and the alighting time in the reservation information may be transmitted.

In the operation management apparatus 200 of the present embodiment, for example, the operation schedule information generated in step S1405 and the reservation information generated from the operation schedule information may be deleted when the operation of the on-demand bus indicated by the operation schedule information is finished.

Specifically, for example, when the operation of the on-demand bus based on the operation schedule information of the schedule ID “S₁” illustrated in FIGS. 7A and 7B is finished, the operation schedule information of the schedule ID “S₁” and the reservation information (refer to FIG. 8) including the schedule ID “S₁” may be deleted.

The operation schedule information may be transmitted to the vehicular terminal 400. When the vehicular terminal 400 receives the operation schedule information, the vehicular terminal 400 may display the operation schedule information on the display device using the display control unit 412.

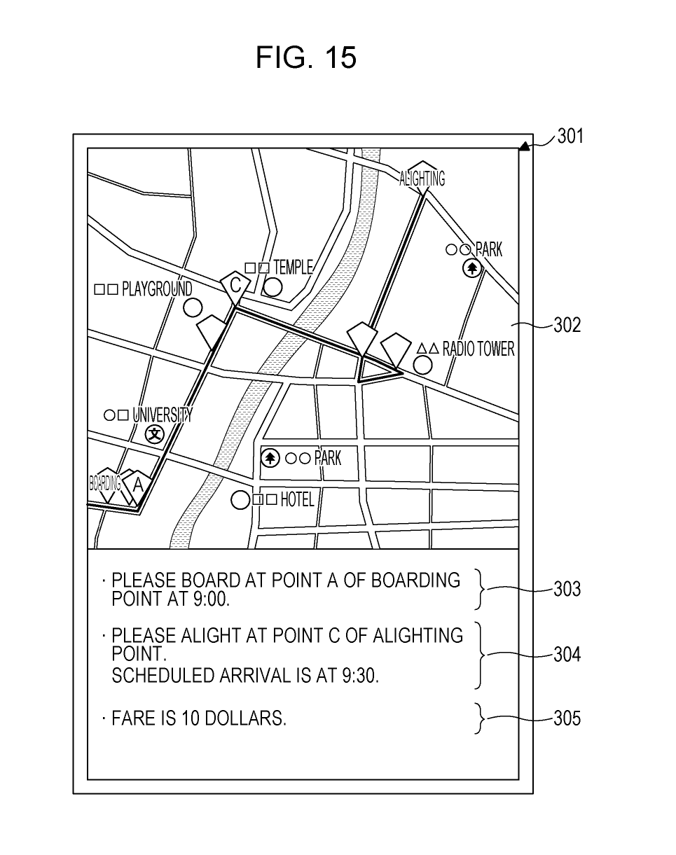

Next, an example of display on the terminal apparatus 300 that receives the reservation information will be described with reference to FIG. 15. FIG. 15 is a diagram illustrating an example of display on the terminal apparatus of the first embodiment.

A map 302 that illustrates the operation path of the on-demand bus boarded by the user of the terminal apparatus 300, and messages 303, 304, and 305 are displayed in a screen 301 illustrated in FIG. 15.

The message 303 is a message for notifying the boarding time and the boarding point. The message 304 is a message for notifying the alighting time and the alighting point. The message 305 is a message for notifying the charge.

According to the present embodiment thus far, the operation path is decided from a plurality of paths that pass through boarding/alighting points set within certain ranges from the departure location and the destination of each user, based on the satisfaction level of each user acquired by taking the walking time, the in-vehicle travel time, and the charge into consideration. Therefore, according to the present embodiment, convenience for users and operation efficiency from the viewpoint of a transportation operator can be improved in the operation of the on-demand bus.

### Second Embodiment

Hereinafter, a second embodiment will be described with reference to the drawings. The second embodiment is different from the first embodiment in that the user is charged and awarded an incentive when the reservation information is generated. Thus, in the following description of the second embodiment, only differences from the first embodiment will be described. Parts having the same functional configuration as the first embodiment will be designated by the same reference signs as used in the description of the first embodiment, and descriptions of such parts will not be repeated.

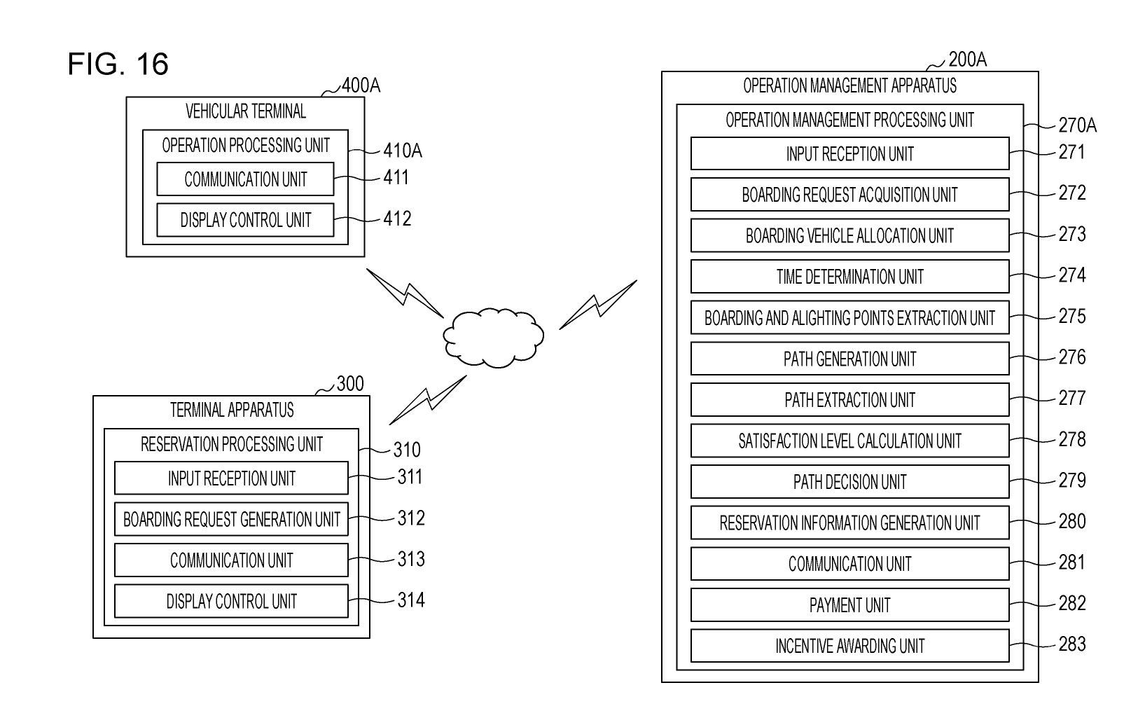

FIG. 16 is a diagram for describing a functional configuration of an operation management apparatus of the second embodiment. An operation management apparatus 200A of the present embodiment includes an operation management processing unit 270A.

The operation management processing unit 270A of the present embodiment includes a payment unit 282 and an incentive awarding unit 283 in addition to each unit included in the operation management processing unit 270 of the first embodiment.

The payment unit 282 performs a payment process for the charges based on a preregistered bank account, credit card information, or the like of the user when the reservation information is generated.

The incentive awarding unit 283 awards the user a discount of the charge or points instead of a discount as an incentive for boarding. For example, the incentive awarding unit 283 of the present embodiment may retain information that indicates types of users and types of awarded incentives.

Specifically, for example, when there is a difference in satisfaction level between users allocated to the same boarding vehicle, a user having a low satisfaction level may be awarded an incentive. In the present embodiment, awarding an incentive in such a manner can reduce differences in satisfaction level between users boarding the same boarding vehicle.

For example, the incentive awarding unit 283 of the present embodiment may award a user having a long walking time or a user of which the in-vehicle travel time is a long time period exceeding a constraint. In the present embodiment, awarding an incentive in such a manner can promote boarding of a user having a long walking time or a long in-vehicle travel time.

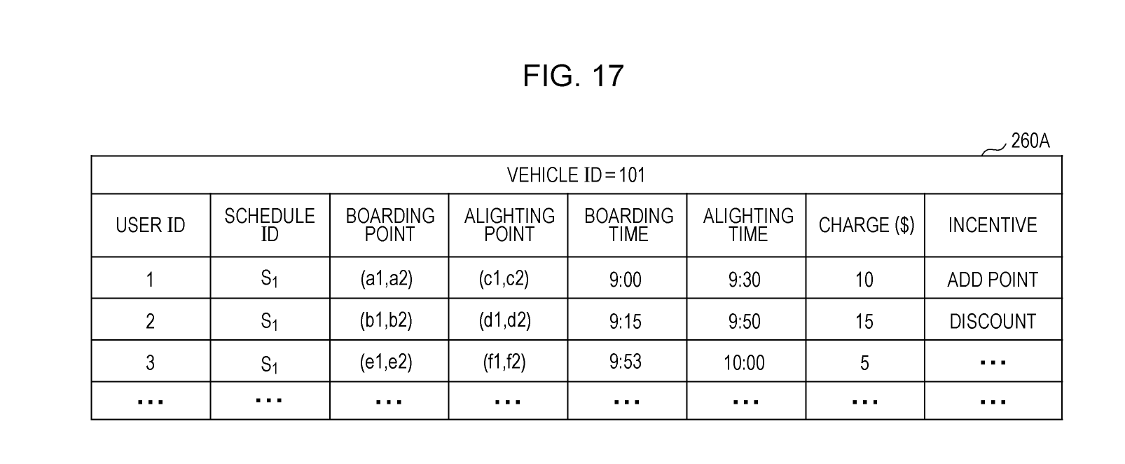

Hereinafter, a reservation database of the present embodiment will be described with reference to FIG. 17. FIG. 17 is a diagram illustrating one example of the reservation database of the second embodiment.

A reservation database 260A of the present embodiment includes a field “incentive” in addition to the fields of information included in the reservation database 260.

The value of the field “incentive” indicates the content of an incentive awarded to the user indicated by the corresponding user ID.

In the example in FIG. 17, points are added for the user of the user ID “1” as an incentive, and the user of the user ID “2” receives a discount as an incentive.

For example, the user may select any awarded incentive.

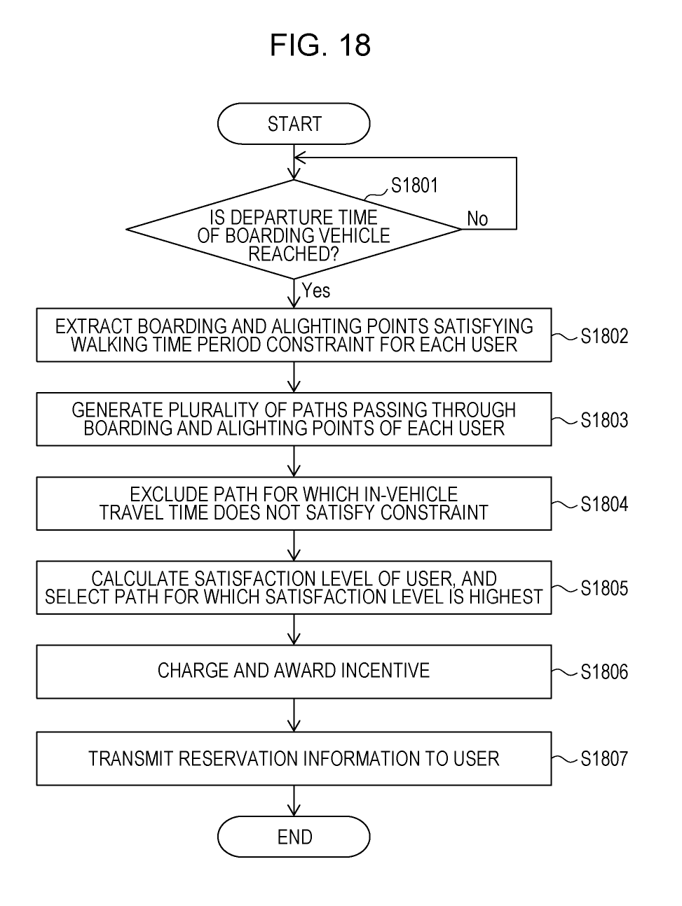

Next, the operation of the operation management apparatus 200A of the present embodiment will be described with reference to FIG. 18. FIG. 18 is a flowchart for describing the operation of the operation management apparatus of the second embodiment.

Processes of step S1801 to step S1805 in FIG. 18 are the same as the processes of step S1401 to step S1405 in FIG. 14. Thus, descriptions of such processes will not be repeated.

When the operation path of the on-demand bus is decided in step S1805, the operation management processing unit 270A performs the payment process for the charge for each user using the payment unit 282, and awards an incentive using the incentive awarding unit 283 (step S1806).

Next, the operation management processing unit 270A transmits the reservation information for each user to the terminal apparatus 300 of the user (step S1807), and finishes the process.

According to the present embodiment thus far, users can make a reservation for the on-demand bus and pay the charge by themselves. Furthermore, according to the present embodiment, awarding an incentive for boarding can resolve the feeling of unfairness among the users and promote boarding of a user having a long walking time or a long in-vehicle travel time.

### Third Embodiment

Hereinafter, a third embodiment will be described with reference to the drawings. The third embodiment is different from the first embodiment in that a plurality of users share boarding/alighting points. Thus, in the following description of the third embodiment, only differences from the first embodiment will be described. Parts having the same functional configuration as the first embodiment will be designated by the same reference signs as used in the description of the first embodiment, and descriptions of such parts will not be repeated.

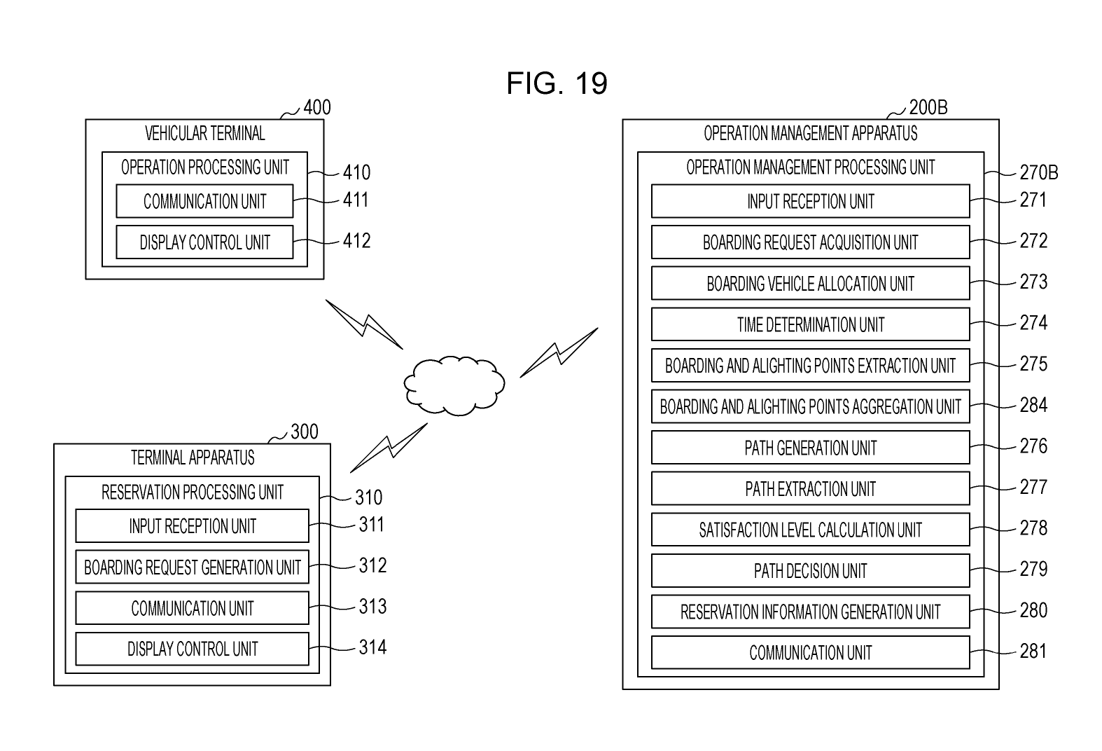

FIG. 19 is a diagram for describing a functional configuration of an operation management apparatus of the third embodiment. An operation management apparatus 200B of the present embodiment includes an operation management processing unit 270B.

The operation management processing unit 270B of the present embodiment includes a boarding/alighting points aggregation unit 284 in addition to each unit included in the operation management processing unit 270 of the first embodiment.

The boarding/alighting points aggregation unit 284 of the present embodiment aggregates boarding/alighting points close in distance to each other among the plurality of boarding/alighting points extracted for each user, and sets boarding/alighting points shared by the plurality of users. In other words, among the plurality of boarding/alighting points set for each boarding request, the boarding/alighting points aggregation unit 284 sets boarding/alighting points between which the distance is shorter than or equal to a predetermined distance, as a common boarding/alighting point for a plurality of boarding requests.

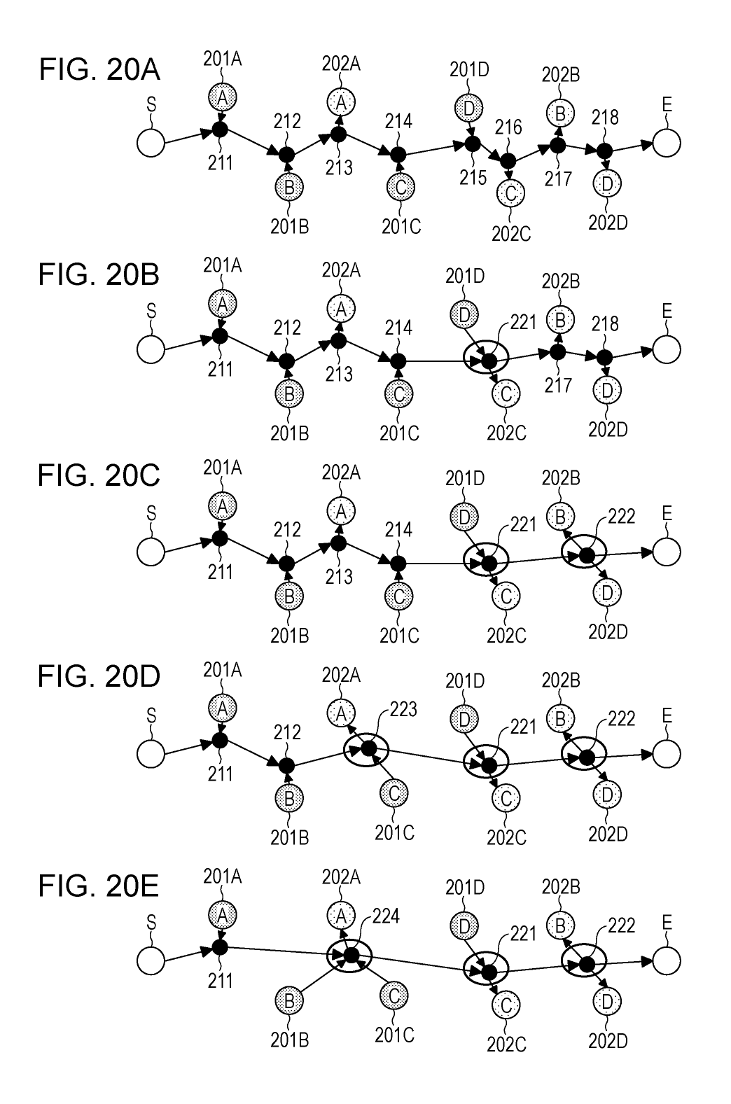

Hereinafter, aggregation of boarding/alighting points will be described with reference to FIGS. 20A to 20E. FIGS. 20A to 20E are diagrams for describing aggregation of boarding/alighting points in the third embodiment.

FIG. 20A illustrates an example of a generated path, and FIGS. 20B to 20E illustrate an example of a path in which the boarding/alighting points illustrated in FIG. 20A are aggregated.

A path to an ending point E from a starting point S illustrated in FIG. 20A is a path in which boarding/alighting points are set for each of users A to D who are passengers of the on-demand bus.

The user A walks to a boarding point 211 from a departure location 201A, boards the on-demand bus, alights at an alighting point 213, and walks to a destination 202A. The user B walks to a boarding point 212 from a departure location 201B, boards the on-demand bus, alights at an alighting point 217, and walks to a destination 202B.

The user C walks to a boarding point 214 from a departure location 201C, boards the on-demand bus, alights at an alighting point 216, and walks to a destination 202C. The user D walks to a boarding point 215 from a departure location 201D, boards the on-demand bus, alights at an alighting point 218, and walks to a destination 202D.

In the path illustrated in FIG. 20B, the boarding point 215 of the user D and the alighting point 216 of the user C that are boarding/alighting points closest in distance to each other in the path illustrated in FIG. 20A are aggregated into a boarding/alighting point 221. The boarding/alighting point 221 is shared by the user C and the user D.

In the present embodiment, for example, the boarding/alighting point 221 may be the center between the boarding point 215 and the alighting point 216, or a point near the boarding point 215 and the alighting point 216. For example, the boarding/alighting point 221 may be the departure location of the user D or the destination of the user C.

The boarding/alighting point 221 is set when the distance from each of the departure location 201D of the user D and the destination 202C of the user C to the boarding/alighting point 221 is within a predetermined walkable range.

In the example in FIG. 20B, while the walking time of the user D to the boarding/alighting point 221 from the departure location 201D and the walking time of the user C to the destination 202C from the boarding/alighting point 221 are extended, the number of stops of the on-demand bus in the whole path can be decreased. Therefore, the operation efficiency of the on-demand bus can be improved.

In FIG. 20C, the alighting point 217 of the user B and the alighting point 218 of the user D that are boarding/alighting points closest in distance to each other in the path illustrated in FIG. 20B are aggregated into a boarding/alighting point 222. The boarding/alighting point 222 is shared by the user B and the user D.

In the example in FIG. 20C, while the walking time of the user B to the destination 202B from the boarding/alighting point 222 and the walking time of the user D to the destination 202D from the boarding/alighting point 222 are extended, the number of stops of the on-demand bus can be further decreased from that in the path illustrated in FIG. 20B.

In FIG. 20D, the alighting point 213 of the user A and the boarding point 214 of the user C in the path illustrated in FIG. 20C are aggregated into a boarding/alighting point 223. The boarding/alighting point 223 is shared by the user A and the user C.

In the example in FIG. 20D, while the walking time of the user A to the destination 202A from the boarding/alighting point 222 and the walking time of the user C to the boarding/alighting point 223 from the departure location 201C are extended, the number of stops of the on-demand bus can be further decreased from that in the path illustrated in FIG. 20C.

In FIG. 20E, the boarding point 212 of the user B and the boarding/alighting point 223 in the path illustrated in FIG. 20D are aggregated into a boarding/alighting point 224. The boarding/alighting point 224 is shared by the user A, the user B, and the user C.

In the example in FIG. 20E, while the walking time of the user A to the destination 202A from the boarding/alighting point 224 and time periods of walking of the users B and C to the boarding/alighting point 224 from the departure locations 201B and 201C are extended, the number of stops of the on-demand bus can be further decreased from that in the path illustrated in FIG. 20D.

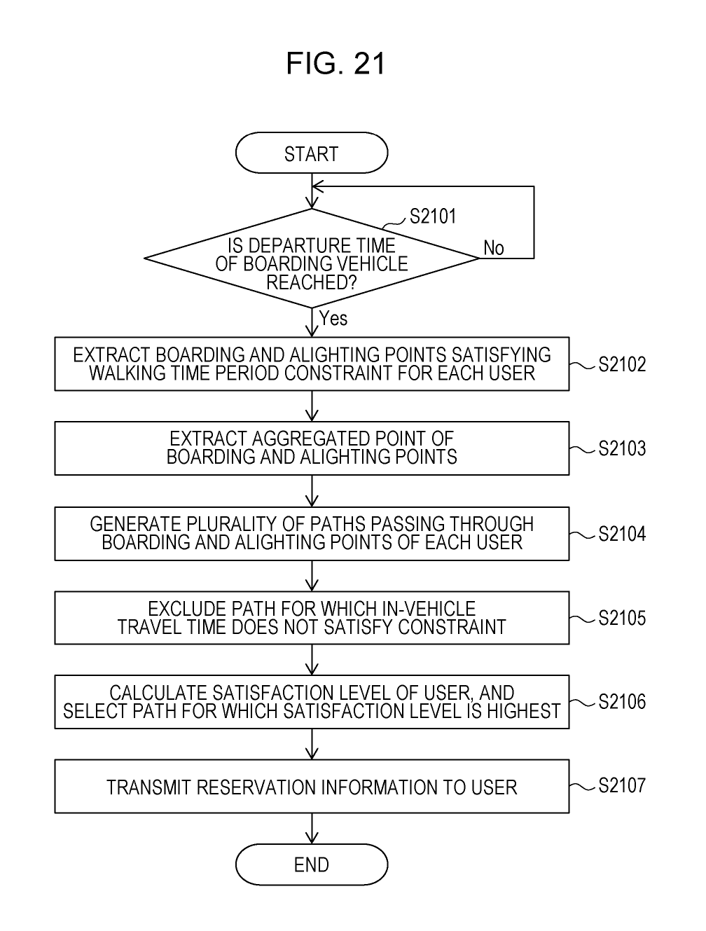

Next, the operation of the operation management apparatus 200B of the present embodiment will be described with reference to FIG. 21. FIG. 21 is a flowchart for describing the operation of the operation management apparatus of the third embodiment.

Processes of step S2101 and step S2102 in FIG. 21 are the same as the processes of step S1401 and step S1402 in FIG. 14. Thus, descriptions of such processes will not be repeated.

After step S2102, the operation management processing unit 270B extracts, using the boarding/alighting points aggregation unit 284, a point into which the boarding/alighting points extracted in step S2102 are aggregated (step S2103).

Specifically, the boarding/alighting points aggregation unit 284 of the present embodiment may aggregate the boarding/alighting points using a clustering method such as a k-means method. For example, the boarding/alighting point that is newly set by the boarding/alighting points aggregation unit 284 in step S2103 may be the center (or the centroid) of the plurality of boarding/alighting points or a point near the center of the plurality of boarding/alighting points, or may be any one of the plurality of boarding/alighting points.

After step S2103, the path generation unit 276 generates paths as operation path candidates using the boarding/alighting points extracted by the boarding/alighting points extraction unit 275 and the boarding/alighting points aggregation unit 284 (step S2104).

Processes of step S2104 to step S2107 are the same as the processes of step S1403 to step S1406 in FIG. 14. Thus, descriptions of such processes will not be repeated.

According to the present embodiment thus far, aggregating the boarding/alighting points extracted for each passenger of the on-demand bus can suppress frequent stops of the on-demand bus after moving a short distance, and can improve operation efficiency.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An operation management method performed by a computer, the method comprising:
acquiring requests from a plurality of users for boarding and alighting including a departure location and a destination;
associating each request with a vehicle corresponding to the departure location and the destination;
setting, for each of the requests, a boarding/alighting point within a predetermined range including the departure location and within a predetermined range including the destination, respectively;
generating a plurality of paths that pass through the boarding/alighting points; and
selecting an operation path of the vehicle from the plurality of paths.

2. The operation management method according to claim 1,
wherein each of the boarding/alighting points is set by referring to a storage unit that stores map data and information indicating attributes of a road including a road width and a number of lanes.

3. The operation management method according to claim 1, further comprising:
for each of the plurality of paths, calculating a satisfaction level of each user for each request based on a walking time from the departure location to a boarding point, a walking time from an alighting point to the destination, an in-vehicle travel time from the boarding point to the alighting point, and a boarding charge for the vehicle;
for each of the plurality of paths, calculating a total of the satisfaction levels of the requests; and
selecting a path for which the total of the satisfaction levels of the requests is the highest from the plurality of paths.

4. The operation management method according to claim 3, further comprising:
awarding an incentive to a user who makes a request in which the in-vehicle travel time from the boarding point to the alighting point is longer than or equal to a first predetermined time period, or at least one of the walking times is longer than or equal to a second predetermined time period.

5. The operation management method according to claim 3, further comprising:
excluding a path, which includes an in-vehicle travel time for an user longer than a second predetermined threshold, from the plurality of paths.

6. The operation management method according to claim 3, further comprising:
excluding a path, for which a variance of the satisfaction levels of the plurality of users is higher than or equal to a threshold, from the plurality of paths.

7. The operation management method according to claim 1, further comprising:
for each of the plurality of paths, calculating an in-vehicle time that is taken when the vehicle travels to an ending point from a starting point of the path; and
excluding a path, for which the calculated in-vehicle travel time is longer than a certain predetermined time period, from the plurality of paths.

8. The operation management method according to claim 1, further comprising:
when a distance between a plurality of boarding/alighting points is shorter than or equal to a predetermined distance, setting a common boarding/alighting point for a plurality of requests for which the plurality of boarding/alighting points are set.

9. The operation management method according to claim 8,
wherein the common boarding/alighting point is the departure location or the destination included in one of the plurality of requests, a center of the plurality of boarding/alighting points, or a point near the center.

10. The operation management method according to claim 1,
wherein the boarding/alighting points include the departure location and/or the destination.

11. An operation management apparatus comprising:
a memory; and
a processor coupled to the memory and configured to perform a process including:
acquiring requests from a plurality of users for boarding and alighting including a departure location and a destination;
associating each request with a vehicle corresponding to the departure location and the destination;
setting, for each of the requests, a boarding/alighting point within a predetermined range including the departure location and within a predetermined range including the destination, respectively;
generating a plurality of paths that pass through the boarding/alighting points; and
selecting an operation path of the vehicle from the plurality of paths.

12. A non-transitory computer-readable storage medium storing an operation management program to cause a computer to perform a process including:
acquiring requests from a plurality of users for boarding and alighting including a departure location and a destination;
associating each request with a vehicle corresponding to the departure location and the destination;
setting, for each of the requests, a boarding/alighting point within a predetermined range including the departure location and within a predetermined range including the destination, respectively;
generating a plurality of paths that pass through the boarding/alighting points; and
selecting an operation path of the vehicle from the plurality of paths.

13. An operation management system comprising a terminal device and an operation management apparatus coupled to each other, the operation management apparatus comprising:
a memory; and
a processor coupled to the memory and configured to perform a process including:
acquiring requests input to the terminal device from a plurality of users for boarding and alighting including a departure location and a destination;
associating each request with a vehicle corresponding to the departure location and the destination;
setting, for each of the requests, a boarding/alighting point within a predetermined range including the departure location and within a predetermined range including the destination, respectively;
generating a plurality of paths that pass through the boarding/alighting points;
selecting an operation path of the vehicle from the plurality of paths;
generating reservation information including the boarding/alighting points and respective boarding and alighting times of the vehicle based on the requests and the operation path; and
transmitting the reservation information to the terminal device.
